(19) United States
(12) Patent Application Publication
(10) Pub. No.: US 2014/0346267 A1
(43) Pub. Date: Nov. 27, 2014

(54) WINDING DEVICE FOR A PE FILTER CORE

(71) Applicant: Sheng Ci Machinery Co., Ltd., Taichung City (TW)

(72) Inventor: Han-Chia LIN, Taichung City (TW)

(73) Assignee: Sheng Ci Machinery Co., Ltd., Taichung City (TW)

(21) Appl. No.: 14/275,014

(22) Filed: May 12, 2014

(30) Foreign Application Priority Data
May 24, 2013 (TW) 102118542

(51) Int. Cl. B29C 43/46

(52) U.S. Cl. CPC B29C 43/46
USPC 242/362.2

(57) ABSTRACT

A winding device for a PE filter core includes a base pivotally provided thereon with a winding unit formed with a screw rod, and a material winding tube, which is short than the screw rod, is fitted around the screw rod. A driving unit is connected with the winding unit for both driving the screw rod and the material winding tube to rotate coaxially and reversely. By so designing, PE threads can be wound to form a PE filter core by the material winding tube, and the PE filter core can be removed from the material winding tube by the screw rod. Thus, PE filter cores can be produced quickly and incessantly.

### BACKGROUND OF THE INVENTION

1. Field of the Invention

This invention relates to a winding device, particularly to one for winding a PE filter core.

2. Description of the Prior Art

PE filter cores have characteristics of corrosion resistance, solvent resistance, large discharge, strong capability of anti-pollution and low price; therefore, PE filter cores are extensively employed for water treatment and chemical filtration. A conventional PE core is mostly produced by winding PE threads around a roller to make up a PE filter core.

However, after a PE filter core is shaped, the PE filter core has to be removed from the roller so that a next PE filter core can be continuously shaped on the roller, thus inconvenient and necessary to take much time in producing PE filter cores. Therefore, the conventional method of making up a PE filter core is necessary to be improved.

### SUMMARY OF THE INVENTION

The objective of this invention is to offer a winding device for a PE filter core, able to produce PE filter cores quickly and continuously. The winding device for a PE filter core includes a base formed with a pivotal hole. A winding unit is pivotally combined with the pivotal hole of the base and provided with a screw rod having its outer side fitted with a material winding tube that is shorter than the screw rod. A driving unit is installed on the base and connected with the winding unit for driving both the screw rod and the material winding tube to rotate coaxially and reversely.

The winding device for a PE filter core is to have the driving unit actuating both the screw rod and the material winding tube to rotate coaxially and reversely. The material winding tube functions to have PE threads wound to make up a PE filter core, while the screw rod functions to remove the PE filter core from the material winding tube and thus, PE filter cores can be produced quickly and incessantly.

### BRIEF DESCRIPTION OF DRAWINGS

This invention will be better understood by referring to the accompanying drawings, wherein:

FIG. 1 is a perspective view of a first preferred embodiment of a winding device for a PE filter core in the present invention;

FIG. 2 is a cross-sectional view of the first preferred embodiment of a winding unit in the present invention;

FIG. 3 is a plane view of a screw rod in the first preferred embodiment in the present invention;

FIG. 4 is an upper view of a driving unit in the first preferred embodiment in the present invention;

FIG. 5 is a plane view of the driving unit in the first preferred embodiment in the present invention;

FIG. 6 is a cross-sectional view of a material injection unit in the first preferred embodiment in the present invention;

FIG. 7 is a schematic view of the first preferred embodiment of a winding device for a PE filter core in a using condition in the present invention;

FIG. 8 is an upper view of a driving unit in the second embodiment of the present invention; and

FIG. 9 is a plane view of the driving unit in the second preferred embodiment in the present invention.

### DETAILED DESCRIPTION OF THE PREFERRED EMBODIMENT

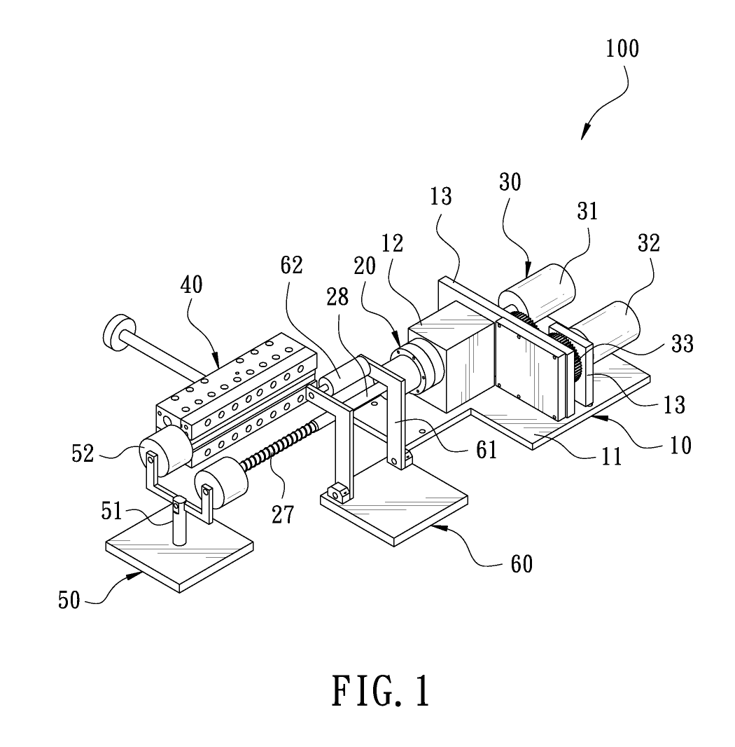

A first preferred embodiment of a winding device 100 for a PE filter core in the present invention, as shown in FIG. 1, includes a base 10, a winding unit 20, a driving unit 30, a material injection unit 40, a support unit 50 and a material press unit 60 as main components combined together.

The base 10 is provided with a bottom plate 11 and mounted thereon with a pivotal seat 12 bored with a pivotal hole 121, and a pair of vertical plates 13 is fixed near one side of the pivotal seat 12.

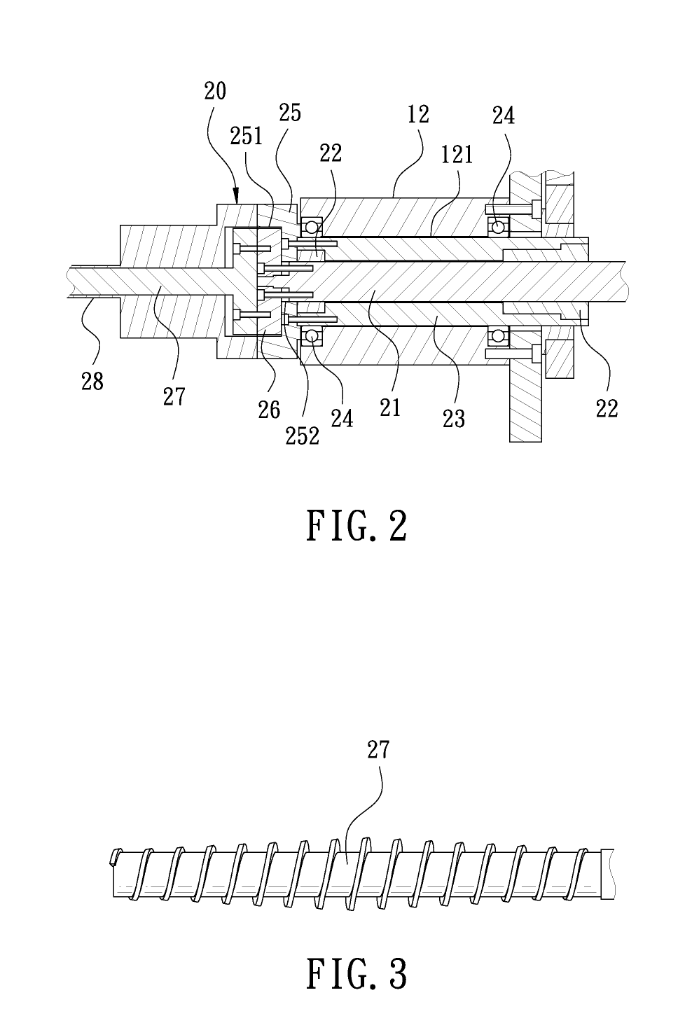

The winding unit 20, referring to FIGS. 1 and 2, is pivotally combined with the pivotal hole 121 of the pivotal seat 12 and provided with a central spindle 21 to be inserted in the pivotal hole 121. The central spindle 21 is fitted thereon with at least two internal bearings 22, which have their outer circumferential sides axially fitted with a bushing 23 along the central spindle 21, and the bushing 23 is fitted thereon with at least two external bearings 24 having their outer circumferential sides resisting the inner wall of the pivotal hole 121. Further, the bushing 23 has one end connected with an external rotary disc 25 formed with an accommodating groove 251 having its bottom disposed with a spindle bore 252 for the central spindle 21 to be inserted therethrough. Furthermore, the accommodating groove 251 is received therein with an internal rotary disc 26 that is connected with the central spindle 21 and has another side connected with a screw rod 27, and height of the teeth crest of the screw rod 27 gradually increases from two ends toward the middle, as shown in FIG. 3. A material-winding tube 28 which is shorter than the screw rod 27 is fitted around the screw rod 27 and connected with the external rotary disc 25.

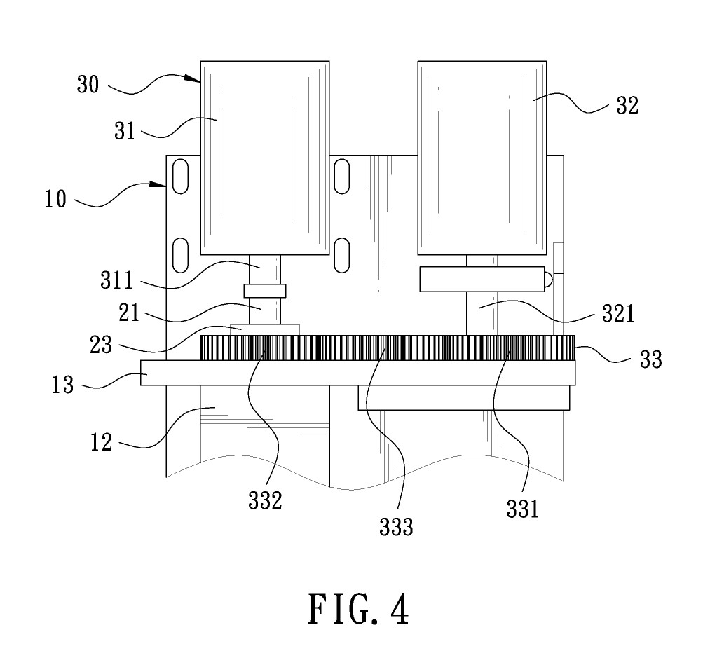

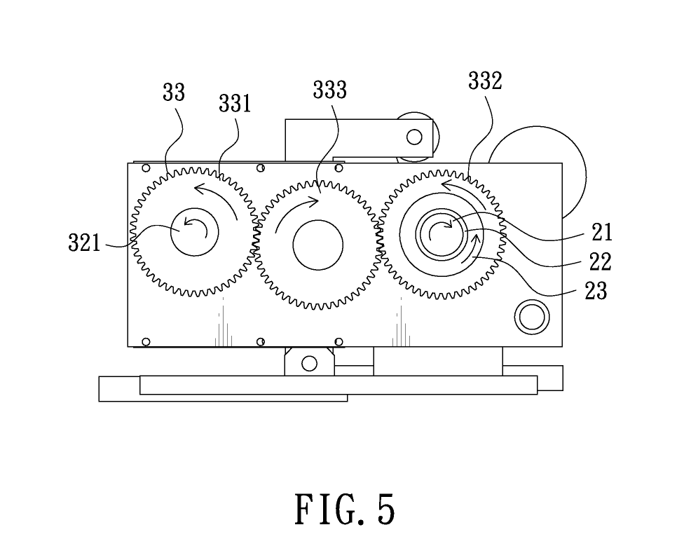

The driving unit 30 is assembled on the base 10 and connected with the winding unit 20, able to drive the screw rod 27 and the material winding tube 28 to rotate coaxially and reversely. Referring to FIGS. 4 and 5, the driving unit 30 in this preferred embodiment is provided with a first motor 31 having a first output shaft 311 connected with another end of the central spindle 21. The driving unit 30 is further provided with a second motor 32 with a second output shaft 321, and a gear set 33 is connected with the second output shaft 321 and another end of the bushing 23. The gear set 33 is composed of a first gear 331 combined with the second output shaft 321, a second gear 332 assembled with the bushing 23 and at least one third gear 333 pivotally assembled with the vertical plates 13 and mutually engaged with both the first gear 331 and the second gear 332. Thus, the first motor 31 and the second motor 32 can be rotated in different directions for simultaneously driving the screw rod 27 and the material winding tube 28 to rotate coaxially and reversely.

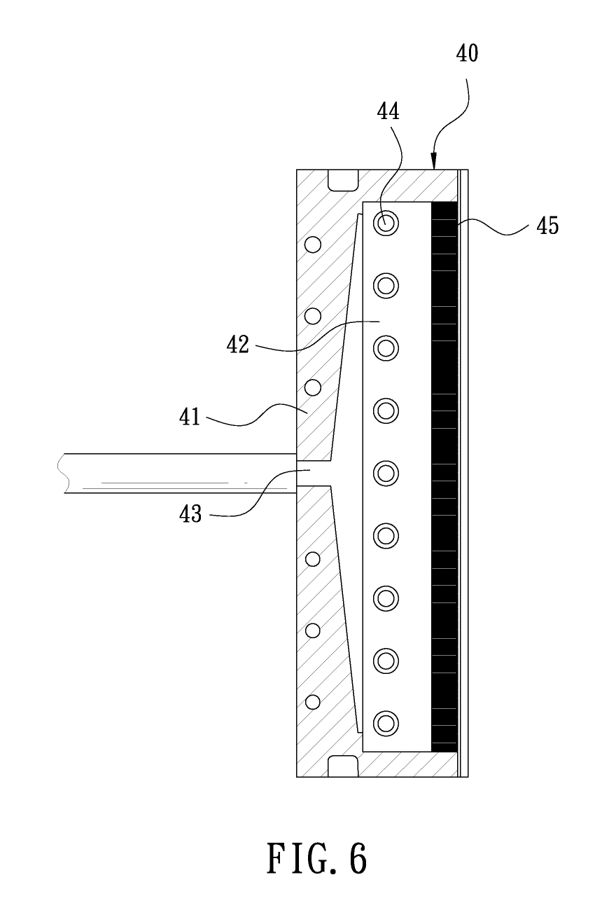

The material injection unit 40, referring to FIGS. 1 and 6, is positioned at one side of the winding unit 20 and formed with an injection head 41 disposed therein with a material chamber 42 and having its circumferential side provided with a feeding opening 43 communicating with the material chamber 42, a plurality of air intakes 44 and material injection holes 45.

The support unit 50 is mounted at one end of the winding unit 20, opposite to the driving unit 30, and fixed with a support frame 51 pivotally installed thereon with a pair of support wheels 52, which are respectively positioned at two sides of the screw rod 27.

The material press unit 60 is disposed at one side of the winding unit 20, opposite to the material injection unit 40 and formed with a material press frame 61 pivotally assembled thereon with a material press wheel 62 positioned above the material winding tube 28.

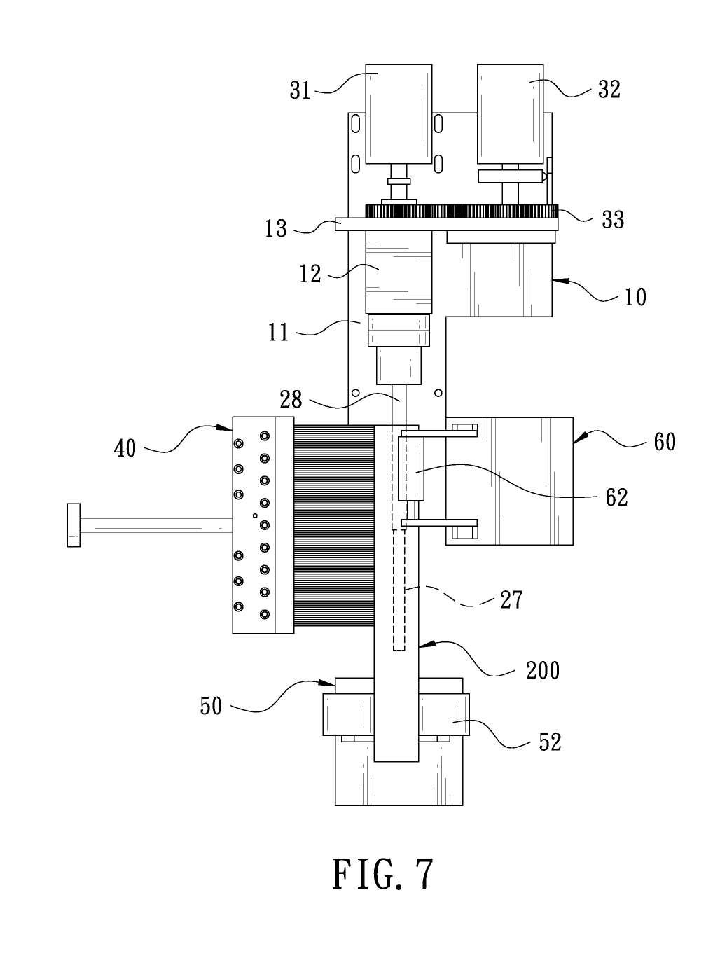

In using, referring to FIG. 7, the driving unit 30 is started first to let the first output shaft 311 of the first motor 31 directly drive the central spindle 21 together with the internal rotary disc 26 to actuate the screw rod 27 to rotate and let the second output shaft 321 of the second motor 32 drive the gear set 33 to actuate the bushing 23 together with the external rotary disc 25 to turn and drive the material winding tube 28 to rotate in a direction reverse to the rotating direction of the screw rod 27. Subsequently, PE material is poured into the material chamber 42 via the feeding opening 43, and air is input into the material chamber 42 through the air intakes 44 to have the PE material injected out through the material injection holes 45 and formed into a plurality of PE threads. Simultaneously, the PE threads will be wound up by the material winding tube 28 to make up a PE filter core 200 and meanwhile, the PE filter core 200 will be taken away from the material winding tube 28 by the screw rod 27. Thus, PE filter cores 200 can be produced quickly and continuously.

One special feature of this invention is that height of serrated crest of the screw rod 27 gradually increases from two ends toward the middle of the screw rod 27 so the screw rod 27 can effectively and quickly remove the PE filter core 200.

Another special feature of this invention is that the PE filter core 200 removed by the screw rod 27 can be inserted and supported between the two support wheels 52 of support unit 50, and the material press wheel 62 of the material press unit 60 can function to press the PE filter core 200 for controlling the thickness of the PE filter core 200 and making the surface of the PE filter core 200 flat and smooth.

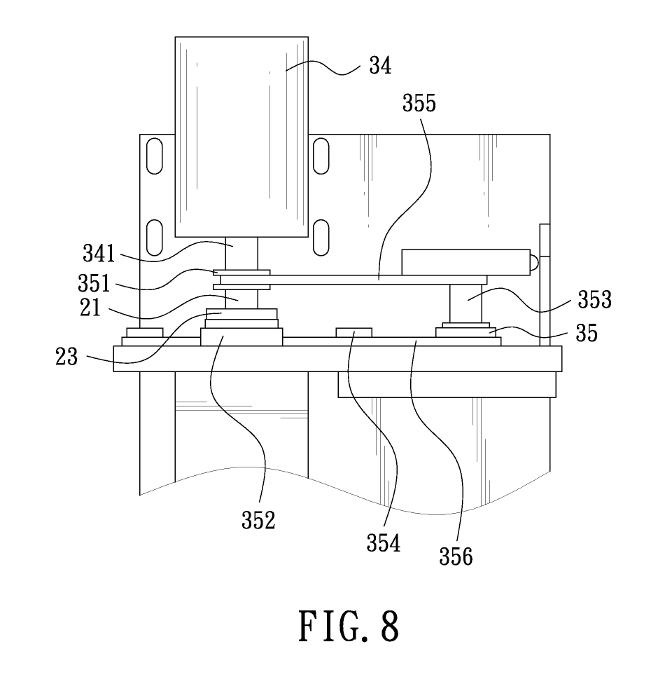

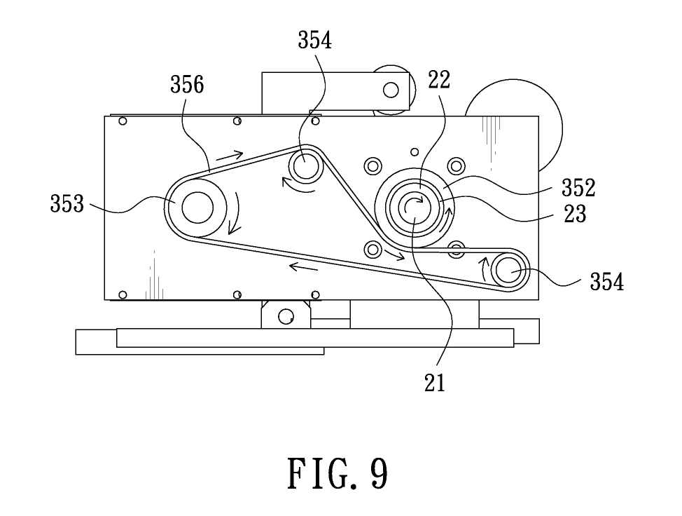

A second preferred embodiment of a winding device 100 for a PE filter core in the present invention as shown in FIGS. 8 and 9, has almost the same structure as that of the first preferred embodiment, except that the driving unit 30 is provided with a third motor 34 with a third output shaft 341 that is connected with another end of the bushing 23, and a chain wheel set 35 is connected with the third output shaft 341 and another end of the bushing 23. The chain wheel set 35 is composed of a first revolving ring 351 mounted at the circumferential side of the third output shaft 341, a second revolving ring 352 assembled at the circumferential side of the bushing 23, and a rotary shaft 353 and plural rotating wheels 351 pivotally fixed between the two vertical plates 13 of the base 10. A first chain 355 is connected between the first revolving ring 351 and the rotary shaft 353, and a second chain 356 is connected with the second revolving ring 352 and the rotating wheels 354 and the rotary shaft 353. Thus, when the third motor 34 is started to rotate, the third output shaft 341 will directly drive the central spindle 21 together with the screw rod 27 to rotate, and the first revolving ring 351 will drive the first chain 355 together with the rotary shaft 353 to rotate to let the rotary shaft 353 drive the second chain 356 together with the second revolving ring 352 to rotate and actuate the material winding tube 28 to rotate in a direction reverse to the rotating direction of the screw rod 27. Thus, the screw rod 27 and the material winding tube 28 can be driven to rotate coaxially and reversely by one single motor.

While the preferred embodiments of the invention have been described above, it will be recognized and understood that various modifications may be made therein and the appended claims are intended to cover all such modifications that may fall within the spirit and scope of the invention.

What is claimed is:

1. A winding device for a PE filter core comprising:
a base formed with a pivotal hole;
a winding unit pivotally combined with said pivotal hole, said winding unit provided with a screw rod, said screw rod fitted thereon with a material winding tube, said material winding tube being shorter than said screw rod; and
a driving unit set on said base and connected with said winding unit, said driving unit able to drive said screw rod and said material winding tube to rotate coaxially and reversely at the same time.

2. The winding device for a PE filter core as claimed in claim 1, wherein said winding unit is formed with a central spindle to be inserted in said pivotal hole of said base, said central spindle fitted thereon with at least two internal bearings, said internal bearings having their outer circumferential sides axially fitted with a bushing along said central spindle, said bushing fitted thereon with at least two external bearings, said external bearings having outer circumferential sides resisting inner walls of said pivotal hole, said bushing having one end connected with an external rotary disc, said external rotary disc disposed with an accommodating groove, said accommodating groove having a bottom bored with a spindle hole for said central spindle to be inserted therethrough, an internal rotary disc received in said accommodating groove, said internal rotary disc connected with said central spindle, said internal rotary disc further connected with said screw rod, said material winding tube connected with said external rotary disc.

3. The winding device for a PE filter core as claimed in claim 2, wherein said driving unit has a first motor formed with a first output shaft connected with another end of said central spindle, said driving unit further provided with a second motor, said second motor formed with a second output shaft, a gear set connected with both said second output shaft and another end of said bushing, said gear set having a first gear assembled with said second output shaft, a second gear fixed with said bushing and at least one third gear pivotally combined with said base and meshed with both said first gear and said second gear.

4. The winding device for a PE filter core as claimed in claim 2, wherein said driving unit is provided with a third motor, said third motor formed with a third output shaft, said third output shaft connected with another end of said bushing, a chain wheel set connected with both said third output shaft and another end of said bushing, said chain wheel set having a first revolving ring fitted around a circumferential side of said third output shaft and a second revolving ring fixed at a circumferential side of said bushing, said chain wheel set further having a rotary shaft and plural rotating wheels pivotally mounted with said base, a first chain connected with both said first revolving ring and said rotary shaft, a second chain connected with said second revolving ring and said rotating wheels and said rotary shaft.

5. The winding device for a PE filter core as claimed in claim 1, wherein height of teeth crest of said screw rod gradually increases from two ends toward the middle of said screw rod.

6. The winding device for a PE filter core as claimed in claim 1, wherein a material injection unit is positioned at one side of said winding unit and formed with a material injection head, said material injection head formed with a material chamber in the interior, said material injection head having a circumferential side disposed with a feeding opening communicating with said material chamber, and a plurality of air intakes and material injection holes.

7. The winding device for a PE filter core as claimed in claim 1, wherein a support unit is provided at one end of said winding unit, opposite to said driving unit, said support unit formed with a support frame, said support frame pivotally assembled thereon with a pair of support wheels, said support wheels respectively positioned at two sides of said screw rod.

8. The winding device for a PE filter core as claimed in claim 1, wherein a material press unit is disposed at one side of said winding unit, opposite to said material injection unit, said material press unit formed with a material press frame, said material press frame pivotally assembled thereon with a material press wheel, said material press wheel positioned above said material winding tube.
